(19) United States
(12) Patent Application Publication
(10) Pub. No.: US 2015/0047402 A1
(43) Pub. Date: Feb. 19, 2015

(54) CONTROLLED RELEASE FERTILISER

(71) Applicants: Gavin Walker, Belfast (GB); Stephen Allen, Belfast (GB); Peter Frost, Belfast (GB)

(72) Inventors: Gavin Walker, Belfast (GB); Stephen Allen, Belfast (GB); Peter Frost, Belfast (GB)

(73) Assignee: The Queen's University of Belfast, Belfast (GB)

(21) Appl. No.: 14/236,203

(22) PCT Filed: Aug. 2, 2012
(86) PCT No.: PCT/GB2012/051880

§ 371 Date: Sep. 8, 2014

(30) Foreign Application Priority Data
Aug. 2, 2011 (GB) 1113313.9

(51) Int. Cl. C05G 3/00; C05F 11/00; C05F 17/00; C05B 17/00

(52) U.S. Cl. CPC C05G 3/0005; C05B 17/00; C05F 11/00; C05F 17/00; C05G 3/0035
USPC 71/10; 71/32; 71/27

(57) ABSTRACT

The present invention provides a fertiliser comprising nutrients adsorbed onto a core material comprising a carbonate mineral. Also provided are methods of producing a solid fertiliser, the method comprising adsorbing nutrients onto a core material comprising a carbonate mineral. The invention also provides a method for treating waste material by anaerobic digestion to produce a nutrient rich liquor and adsorbing nutrients from this liquor onto a core material comprising a carbonate mineral. Also provided are the uses of a carbonate mineral for adsorbing phosphorus from anaerobic digestion liquor and for the control release of phosphorus from a fertiliser.

The present invention relates to solid fertilisers comprising nutrients adsorbed onto a core material comprising a carbonate mineral. The present invention also relates to methods of producing a solid fertiliser, the methods comprising adsorbing nutrients from an anaerobic digestion liquor onto a core material comprising a carbonate mineral.

Anaerobic digestion (AD) processes are becoming increasingly important in the management of human waste. In AD processes, waste such as sewage or food waste is exposed to bacteria in an oxygen limited environment to produce renewable energy in the form of biogas (typically a mixture of methane and carbon dioxide). The energy is released by combustion of methane in the presence of oxygen.

AD processes also produce a digestate—a nutrient rich mixture of solid, sludge and liquid by-products. The solid components are generally separated from the mixture and pelletized to give a fertiliser. The liquid by-product, referred to herein as AD liquor, can also be used as a fertiliser.

One method by which AD liquor is used as fertiliser is simply spraying the liquid over crops. However, any nutrients not immediately taken up by the crops can leach into water systems and lead to eutrophication. In eutrophication, a water system becomes enriched with nutrients. This can lead to excessive growth and decay which, in turn, further imbalances in the water system. For instance, algal blooms can lead to a depletion of oxygen in the water system. A further disadvantage of simply spraying AD liquor over crops is that the liquid fertiliser has to be repeatedly applied to the crops. This is because there is no control release mechanism of the nutrients from the AD liquor.

Korean Patent No. 10-0822377 B1 describes a process of transforming the liquor produced by the AD of livestock excrement into a solid fertiliser. The process involves concentrating the liquor, and mixing the concentrated liquor with a zeolite to form a solid product. However, the present inventors have found that zeolite is only capable of a limited uptake of nutrients and, in particular, has poor uptake of compounds that act as a phosphorus source. Thus, large amounts of such a zeolite based fertiliser would be required to provide sufficient amounts of the required nutrients to a crop.

Inorganic mineral materials other than zeolite, such as dolomite and limestone, have also been used in solid fertilisers. These carbonate mineral materials are known as densifiers (i.e. for padding out other materials), as liming materials for their ability to increase the pH of soil, and as sources of calcium and magnesium. For instance, US 2009/241624 describes a soil amendment comprising a combination of compost that may have been produced by AD of organic material with agricultural liming material such as limestone or dolomite.

US 2003/084693 describes a process for converting sludge that may have been produced by AD of organic waste into a solid fertiliser. In the process, zeolite is used as an ammonia retaining agent, and limestone is used as a densifier. There is minimal, if any, adsorption of nutrients onto the densifier under the conditions of such processes, for instance because the moisture content is too low.

Accordingly, there is a need in the art for a solid fertiliser, and a method for producing a solid fertiliser from an AD liquor, where the solid fertiliser has a high concentration of nutrients adsorbed thereon.

According to a first aspect of the present invention, there is provided a fertiliser comprising phosphorus adsorbed onto a core material comprising a carbonate mineral, wherein the phosphorus is present in an amount of at least 50 mg per 1 g of carbonate mineral.

It has surprisingly been found that carbonate minerals exhibit unexpectedly high adsorption of nutrients that are beneficial to crops. In particular, carbonate minerals exhibit improved adsorption of particular nutrients, for example phosphorus, when compared with other minerals that are known in fertilisers, such as zeolites.

The fertiliser of the invention may comprise phosphorus in an amount of at least 100 mg per 1 g of core material, preferably at least 150 mg per 1 g of core material, more preferably at least 200 mg per 1 g of core material, and most preferably at least 250 mg per 1 g of core material. The fertiliser of the invention may comprise phosphorus in an amount of up to 500 mg per 1 g of core material, up to 400 mg per 1 g of core material, or up to 350 mg per 1 g of core material. The fertiliser of the invention may comprise from 50 mg to 500 mg of phosphorus per 1 g of core material, preferably from 100 mg to 400 mg of phosphorus per 1 g of core material, and more preferably from 150 mg to 350 mg of phosphorus per 1 g of core material. As mentioned above, the phosphorus is adsorbed onto the core material.

The fertiliser may further comprise nitrogen adsorbed onto the core material, in an amount of at least 15 mg per 1 g of core material, preferably at least 40 mg per 1 g of core material, more preferably at least 55 mg per 1 g of core material, and most preferably at least 80 mg per 1 g of core material. The fertiliser of the invention may comprise nitrogen in an amount of up to 350 mg per 1 g of core material, up to 250 mg per 1 g of core material, or up to 150 mg per 1 g of core material. The fertiliser of the invention may comprise from 15 mg to 350 mg of nitrogen per 1 g of core material, preferably from 40 mg to 250 mg of nitrogen per 1 g of core material, and more preferably from 55 mg to 150 mg of nitrogen per 1 g of core material.

The fertiliser may further comprise potassium adsorbed onto the core material, in an amount of at least at least 10 mg per 1 g of core material, preferably at least 20 mg per 1 g of core material, more preferably at least 30 mg per 1 g of core material, and most preferably at least 40 mg per 1 g of core material. The fertiliser of the invention may comprise potassium in an amount of up to 100 mg per 1 g of core material, up to 80 mg per 1 g of core material, or up to 60 mg per 1 g of core material. The fertiliser of the invention may comprise from 10 mg to 100 mg of potassium per 1 g of core material, preferably from 20 mg to 80 mg of potassium per 1 g of core material, and more preferably from 30 mg to 60 mg of potassium per 1 g of core material.

The carbonate mineral may comprise limestone (i.e. CaCO₃ based minerals) or dolomite (i.e. CaMg(CO₃)₂ based minerals). In one instance, the carbonate mineral may comprise limestone. Where the carbonate mineral comprises dolomite, the dolomitic material is preferably finely divided dolomite (dolomite with a particle size of less than 100 microns), thermally activated dolomite (dolomite which has been heated at a temperature of above 600° C. for 1 to 6 hours), or a combination thereof. Most preferably, the carbonate mineral is finely divided dolomite. In one embodiment, the core material may comprise a single carbonate mineral. In an alternative embodiment, the core material may comprise a mixture of carbonate minerals, such as a mixture of limestone and dolomite.

The carbonate mineral, or combination of carbonate minerals, that is used in the present invention may be chosen with a view to the desired purpose of the fertiliser. For instance, whilst limestone exhibits greater adsorption of phosphorus from certain AD liquors, dolomite itself is beneficial as a fertiliser as it is a source of magnesium ions.

The nutrients, for instance phosphates, are adsorbed into micropores which are present both on the outside surface and in the internal structure of carbonate minerals. For instance, micropores in dolomite are typically from 1×10⁻¹⁰ m to 1×10⁻⁶ m, such as about 1×10⁻⁸ m, in diameter. The nutrients chemically bind to the micropore via a thermodynamic process. As the nutrients do not undergo a chemical reaction with the carbonate mineral itself, the carbonate mineral remains chemically and physically intact.

The fertiliser is preferably in the form of granules, which may have a size of from 0.1 to 10 mm, preferably from 1 to 5 mm, and more preferably from 2 to 4 mm. The granules may be of any shape. For instance, the granules may be pellet shaped. The preferred size and shape of the granules will be influenced by the intended use of the fertiliser. For instance, if a very slow release fertiliser is desired, larger granules with a smaller surface area may be used.

The fertiliser may further comprise a binder, preferably a polymeric binder, for example an organic binder. Preferably, the binder is biodegradable. In one embodiment, the binder is a polyether, such as polyethylene glycol (preferably PEG 4000). In another embodiment, the binder is a cellulose derivative, such as methylcellulose or carboxymethylcellulose (preferably carboxymethylcellulose). The binder may comprise a mixture of different binders, such as a mixture of polyether binders and cellulose derivative binders. The polymeric binder may be included in the formulation to improve the mechanical strength of the granules produced.

The binder may also be chosen so as to alter the release rate of the nutrients from the fertiliser. For instance, a fertiliser in which the binder is carboxymethylcellulose will release the nutrients at a faster rate than a fertiliser in which the binder is polyethylene glycol. Without wishing to be bound by theory, it is believed that release rate is influenced by a number of factors. For instance, it is believed that different binders produce difference granule porosity which, in turn, affects dissolution of the fertiliser; that the solubility of different binders affects release; and, to a lesser extent, that the strength of the granule may influence nutrient release.

In one embodiment, the organic binder may be a component of AD liquor. Components of AD liquor that act as an organic binder include cellulosic and ligno-cellulosic fibres, in particular cellulosic and ligno-cellulosic fibres of 10 to 100 micron in length. Without wishing to be bound by theory, these fibres are thought to act as solid bridges between particles.

The granules may comprise less than 10% by weight of moisture, more preferably less than 5% by weight of moisture, and even more preferably less than 3% by weight of moisture. Benefits of a dry product include easier storage, reduced caking of the product, and reduced transportation costs.

The fertiliser, preferably in the form of granules, may further comprise a coating. This coating may comprise an organic wax, such as beeswax, paraffin wax, ceresin or a combination thereof. Alternatively or additionally, the coating may comprise a hydrophobic polymeric compound, such as polyethylene or acrylate latex. The coating may be used to provide additional mechanical strength to the fertiliser, to improve the resistance of the fertiliser to attrition, and to slow the rate of nutrient release from the fertiliser.

The coating layer may be from 10 μm to 1 mm thick, and more preferably from 50 μm to 500 μm thick. The thickness of the coating layer may be chosen so as to alter the solubility of the fertiliser and the release profile of the nutrients in the fertiliser.

The fertiliser may be a multi-profile fertiliser granule, i.e. may comprise one or more layers on the surface of the core material, such that the fertiliser comprises at least two different nutrient release profiles. The nutrient release profile is the rate of release of particular nutrients from the core or the layers. For instance, the core may contain a higher content of phosphorous than the first layer, or vice versa. Alternatively, the core may contain the same amount of phosphorous as the first layer, but the core material may release the phosphorous at a quicker rate than the first layer. As a further alternative, different ratios of nutrients may be contained in the core and the layers. In one embodiment, the fertiliser may comprise one layer in addition to the core material. In another embodiment, the fertiliser may comprise 2, 3, 4 or 5 layers in addition to the core material. In a preferred embodiment 2 layers are added to the core material, to give a fertiliser comprising three different nutrient release profiles.

Multi-profile fertiliser granules allow nutrients to be placed at well defined locations in the granules, which ensures their controlled release at predetermined times. For instance, a nutrient package that is required by a plant at a later stage in its growth can be placed at the core of the granules, and a nutrient package that is immediately required by the plant can be placed in a peripheral layer of the granules. Moreover, leaching of excess material may be controlled in this way.

In one embodiment, the layer materials, as with the core material, comprise a carbonate mineral. In addition, the layers may comprise a binder material. Preferred carbonate minerals and binder materials are as described in relation to the core material. Each layer material has a different nutrient release profile from the previous layer or, if there is no previous layer, the release profile of the core material. Therefore, a fertiliser granule consisting of three layers may have a core material with nutrient release profile A, a first layer material with nutrient release profile B, and a second layer material with nutrient release profile C, in other words an A-B-C granule. A fertiliser granule consisting of three layers may alternatively be an A-B-A granule, with the nutrient release profile of the core material and the second layer being the same.

Where the fertiliser comprises a coating, the coating is preferably on the outside of the fertiliser granule. In a further embodiment, the fertilizer may additionally or alternatively comprise one or more coatings between different layer materials. For instance, the fertiliser may comprise an internal layer of wax, and an internal layer of a polymeric compound.

The nutrient release profiles of the layers and the core material may be controlled by changing one or more of the aforementioned features of the fertiliser. For instance, by varying the composition of the core material or layer materials (e.g. by altering the carbonate mineral and the amount and type of binder); the concentration of particular nutrients in the core material or layer materials; and the coating and its location in the granule.

The fertiliser product may comprise at least 75%, preferably at least 85%, more preferably at least 90%, and most preferably about 95% carbonate mineral, by weight. The fertiliser product may comprise 1-15%, preferably 2-10%, more preferably 3-7%, and most preferably about 5% binder material, by weight. The fertiliser product may comprise 0.1-5%, preferably 0.3-3%, more preferably 0.5-1.0%, and most preferably about 0.75% coating, by weight. Thus, in one embodiment the fertiliser product may comprise 1-15% binder material and 0.1-5% coating, preferably 3-7% binder material and 0.5-1.0% coating, by weight. In this embodiment, carbonate mineral (with associated adsorbed nutrients) may account for the remainder of the weight of the fertiliser product.

According to a further aspect of the present invention, there is provided a method of producing a solid fertiliser, the method comprising adsorbing nutrients from an AD liquor onto a core material comprising a carbonate mineral, wherein the AD liquor comprises less than 20% by weight of solid components.

According to a further aspect of the present invention, there is provided a method of producing a solid fertiliser, the method comprising adsorbing nutrients from an AD liquor onto a core material comprising a carbonate mineral, wherein the AD liquor has a pH of from 2 to 8.

It has surprisingly been found that the carbonate minerals, when used in the method of the present invention, exhibit an unexpectedly high adsorption of nutrients that are beneficial to crops.

Preferably, the AD liquor is substantially free from any solid components that are produced in AD processes. For instance, the AD liquor may comprise less than 20% by weight of solid components, less than 10% by weight of solid components, less than 5% by weight of solid components, less than 3% by weight of solid components, less than 1% by weight of solid components, or less than 0.5% by weight of solid components. In a preferred embodiment, the AD liquor comprises less than 0.1% by weight of solid components. The AD liquor may be separated from solid components by filtration (e.g. filter pressing) or centrifugation. Other methods for separating the AD liquor from solid components are well known in the art, such as settling tanks. The AD liquor may be pathogen free and sterile. Methods for sterilising AD liquor are known in the art.

One of the surprising advantages of the present invention is that the nutrients from the AD liquor which are adsorbed onto the solid core material can be control released, for example to crops. This is in contrast to known prior art methods in which the nutrients from the AD liquor are sprayed onto the crops in liquid form or leach freely from their solid support.

The liquor preferably has a pH of from 2 to 8, more preferably from 3 to 6, and most preferably about 4.5. If necessary, the liquor can be acidified using phosphoric, nitric or sulfuric acid. These acids advantageously add to the nutrient value of the liquor. The adsorption of nutrients by the core material is maximised at these pH levels. In contrast, prior art processes use a sludge having a higher pH, as this may reduce pathogen content (see US 2003/084693).

The nutrients in the liquor may also include a phosphorus source, preferably an organic phosphorus. The phosphorus source may comprise a phosphate, preferably an organic phosphate. Preferred phosphorus sources include phosphoric acid, mono-ammonium phosphate (MAP) and di-ammonium phosphate (DAP). The phosphate source may be present in the AD liquor in an amount of from 250 mg/L, from 500 mg/L, or from 750 mg/L. The phosphate source may be present in the AD liquor in an amount of up to 3000 mg/L, up to 2500 mg/L, or up to 2000 mg/L. Preferably, the phosphate source is present in the AD liquor in an amount of from 250 to 3000 mg/L, from 500 to 2500 mg/L, or from 750 to 2000 mg/L.

The nutrients in the liquor may also include a nitrogen source. The nitrogen source may comprise a nitrate and/or ammonium, such as ammonium phosphate or ammonium chloride. Preferably, the nitrogen source is MAP or DAP. The nitrogen source may be present in the AD liquor in an amount of from 250 mg/L, from 500 mg/L, or from 750 mg/L. The nitrogen source may be present in the AD liquor in an amount of up to 3000 mg/L, up to 2500 mg/L, or up to 2000 mg/L. Preferably, the nitrogen source is present in the AD liquor in an amount of from 250 to 3000 mg/L, from 500 to 2500 mg/L, or from 750 to 2000 mg/L.

The nutrients in the liquor may also include a potassium source. Preferred potassium sources include potassium chloride. The potassium source may be present in the AD liquor in an amount of from 1250 mg/L, from 1500 mg/L, or from 1750 mg/L. The potassium source may be present in the AD liquor in an amount of up to 3250 mg/L, up to 2750 mg/L, or up to 2250 mg/L. Preferably, the potassium source is present in the AD liquor in an amount of from 1250 to 3250 mg/L, from 1500 to 2750 mg/L, or from 1750 to 2250 mg/L. Carbonate minerals have improved adsorption of potassium from AD liquor when compared to zeolites. Without wishing to be bound be theory, this is believed to be due to the existing presence of potassium in zeolite, typically as a mineral called phillipsite (a silicate of sodium, potassium and aluminium).

The fertiliser is preferably an organic fertiliser. Thus, the liquor is preferably from the anaerobic digestion of organic waste. Organic waste sources include food waste, slaughterhouse waste, human waste (i.e. sewage), green waste and manure. Preferably, the organic waste comprises food waste, such as waste vegetable and meat matter. This waste is rich in nutrients that may act as phosphorous, nitrogen and potassium sources.

In a preferred embodiment of the method of the present invention, the nutrients from 1 L of liquor are adsorbed onto from 1 mg to 20 g of core material, more preferably from 5 mg to 10 g of core material, and even more preferably from 10 mg to 5 g of core material. For instance, the core material may be added to the AD liquor in an amount, by weight, of from 1 ppm to 20,000 ppm, more preferably from 5 to 10,000 ppm, and even more preferably from 10 ppm to 5,000 ppm. A higher concentration of nutrient in the liquor will, to a point, result in higher nutrient loading onto the core material. However, the amounts recited herein of core material that are added to the liquor give optimal adsorption of nutrients, as too little carbonate material may result in a high degree of nutrient retention in the AD liquor and too much carbonate material may result in low nutrient adsorption by weight of carbonate material.

Preferably, the carbonate material is exposed to the liquor for a period of at least 24 hours. For instance, the carbonate mineral may be exposed to the liquor for a period of from 24 hours to 72 hours. The carbonate material may be exposed to the liquor at a temperature of at least 15° C. For instance, the carbonate material may be exposed to the liquor at a temperature of from 15 to 40° C., preferably from 20 to 30° C.

The carbonate mineral may be added to the liquor in the form of particles, for example having a particle size of from 0.5 to 100 μm, preferably 0.5 to 50 μm, more preferably 0.5 to 5 μm, even more preferably 1 to 3 μm, and most preferably about 2 μm. Particle size is used throughout the application for the mass mean diameter of the particles. Use of smaller particles increases the adsorption rate of the nutrients onto the carbonate mineral.

After the adsorption step, the particles may be dried. This is to remove the excess moisture from the product. The particles may be dried using tray drying in a fume cupboard, fluidised bed drying, microwave drying, and drying with fan-assisted ovens. Other methods of drying are known to those skilled in the art. Whilst any convective drying method can be used, microwave drying advantageously speeds up the process.

The adsorption product may be dried at a temperature from 40° C. to 160° C., preferably from 70° C. to 130° C. and more preferably at about 105° C.

The method may further comprise the step of forming the particles into granules. Preferably the particles are dried before being formed into granules. As mentioned, the granules may be of any shape. In order that the surface area of the carbonate mineral is maximised during the adsorption of nutrients, the step of forming the granules is preferably carried out after the carbonate mineral has been exposed to the liquor.

By converting the particles into granules, the release rate of the nutrients may be controlled. This is useful in the present invention, where the amount of nutrients in the core material is high. In addition, granules are easier to handle with crops than small particles. For example, prior art powders have a tendency to be blown away from target sites, and are easily washed away. Moreover, the risks that are associated with the handling of fine materials, for example inhalation of the material, are reduced. Granules also have enhanced flow properties when compared to small particles. For instance, small particles have a greater tendency to cake and stick than granular materials. This makes the granular fertiliser easier to apply to a target site using mechanical spreaders than previously known powdered fertilisers.

The particles may be formed into granules by agglomeration. As mentioned above, the granules of the fertiliser product, produced after agglomeration, may have a size of from 0.1 to 10 mm, preferably from 1 to 5 mm, and more preferably from 2 to 4 mm. The agglomeration process can be repeated a number until a significant yield of granules in the desired size range is achieved.

The agglomeration may be carried out using high shear granulation, drum granulation, fluidized bed granulation, twin extrusion or pan granulation. Preferably, the agglomeration is carried out using high shear granulation. This method has been found to give a narrow distribution of granule size. In addition, with high shear granulation, it has been found that a high yield of granules are within the target size range after just one cycle of particle agglomeration. In one embodiment, at least 50%, preferably at least 60%, more preferably at least 70% of granules are within a target size range after just one cycle of agglomeration.

A binder may be used for agglomeration. The binder is preferably as described above. The binder, preferably a polymeric binder, may be added as a solution to the powder in a liquid to solid ratio by weight of from 1:20 to 1:1, preferably from 1:15 to 1:3, and more preferably from 1:10 to 1:5. The binder, preferably a polymeric binder, may be present in the solution at a concentration of from 5 to 70% by weight, from 10 to 60% by weight, or from 20 to 40% by weight.

In a particularly preferred embodiment, the binder is the AD liquor. The benefits of granulating with AD liquor are two-fold. Firstly, in spite of its low viscosity, the AD liquor surprisingly acts as a binder during the granulation process. Without wishing to be bound by any specific theory, it is believed that it is the organic content of the AD liquor, for example cellulosic and ligno-cellulosic fibres, typically present at about 8 to 10% by weight, that imparts adhesional properties on the fluid. Secondly, by using AD liquor as the binder, the nutrient composition of the granules is further boosted.

The granules from the agglomeration process are typically a wet product. The method may further comprise a step for drying the granules. Preferably, the granules are dried to less than 10% by weight of moisture, more preferably less than 5% by weight of moisture, and even more preferably less than 3% by weight of moisture. The granules may be dried according to any of the methods described in relation to drying the powder. The preferred temperature for drying the granules is determined by the presence of a binder. In the absence of a binder, the preferred temperature is as described in relation to drying the powder. In the presence of a binder, the preferred temperature for drying the granules is from 5 to 30° C. less than the melting point of the binder, and most preferably about 20° C. less than the melting point of the binder. For instance, when the granules comprise a polymeric binder, such as polyethylene glycol, the granules may be dried at a temperature of up to 70° C., preferably up to 60° C., and more preferably up to 50° C. When AD liquor is used as the binder, the granules may be dried at a temperature of up to 125° C., preferably up to 115° C., and more preferably up to 105° C.

The method may further comprise the step of screening the granules for size. This quality control step involves passing the, preferably dried, granules through a set of sieves to remove undersized (fines) and over-sized (coarse) granules from the product. As mentioned above, the preferred granule size is from 2 to 4 mm. Granules that are undersized, for example smaller than 2 mm, may be recycled to the agglomeration unit. The method of the present invention may also comprise the step of crushing any granules that are oversized, for example larger than 4 mm. The crushed oversized granules may then be recycled to the agglomeration unit.

The method may further comprise the step of adding a coating to the granules. The coating is preferably as described above. The coating may be applied using methods known in the art. For instance, the coating may be applied via a process of fluidised bed coating.

The method may further comprise the step of packaging the granules. In the packaging step, the product meeting the size and nutrient composition requirements is packed into suitable units, such as boxes, bags or cartons.

In one instance, the method of the present invention further comprises the step of forming one or more layers on the surface of the core material, such that the fertiliser comprises at least two different nutrient release profiles. The one or more layers is/are preferably as described above. The step of forming one or more layers on the surface of the core material comprises the sub-steps of providing a seed granule, and layering particles with different release profiles onto the seed granule.

The layering may be done using granulation, preferably high shear granulation. The granulation conditions are altered in such a way that the main granulation mechanism will be a layering mechanism. The granulation mechanisms are controlled by a parameter called the Stokes number; this is the ratio of the kinetic energy of the particle and the energy dissipated during the collision of the particles. The Stokes number depends on the viscosity, surface tension, the size of the particle and velocity at which the particle is moving. For large particles the layering mechanism is possible at high Stokes number.

To encourage layering, as opposed to agglomeration, the Stokes deformation number should be greater than 0.05, and preferably greater than 0.1. The Stokes deformation number St_{def} is given by:

$${St}_{def} = \frac{{ρ}_{g} {V}_{c}^{2}}{2 {σ}_{v}}$$

where ρ_{g} is the density of the granules, V_{c} is the representative collision velocity and σᵥ is the dynamic tensile strength of the granule.

The dynamic tensile strength of the granules is given by:

$${σ}_{v} = \frac{81}{128} \frac{{( 1 - ɛ )}^{2}}{{ɛ}^{2}} \frac{πμ {V}_{p}}{{d}_{3 , 2}}$$

where ε is the granule porosity, Vₚ is particle velocity (taken to be 10% tip speed of impeller), d_{3,2} is the surface volume mean diameter of the particles, and μ is the binder viscosity.

TABLE 1
preferred granulation conditions for high shear granulation

| | Preferred | More preferred | Most preferred |
|---|---|---|---|
| Impeller Speed (rpm) | 50 to 300 | 100 to 250 | 150 to 200 |
| Liquid/solid ratio | 0.05 to 2.0 | 0.10 to 0.15 | about 0.125 |
| Binder concentration (% w/w) | 5 to 60 | 9 to 50 | 20 to 40 |
| Binder addition time (min) | 0.5 to 5 | 0.5 to 3 | about 1 |
| Granulation time (min) | 1 to 10 | 3 to 5 | about 4 |

| | |
|---|---|
| Binder addition method | Spraying, or squirting with a syringe |

Table 1 shows preferred granulation conditions for high shear granulation. However, by use of the Stokes deformation number (St_{def}), granules may be produced in other granulators, such as drum granulators, under different granulation conditions.

Between the forming of layers, the method preferably further comprises the sub-steps of drying the granules, and screening the granules for size. This ensures that only granules with a desired layer thickness are used when further layers are added. The drying and screening processes may be as described above.

Preferably, the surface of the granules, whether a seed granule or a layered granule, is wet when particles with a different nutrient release profile are added according to the layering method of the present invention. Preferably the powder of each layer is added in a stepwise manner. Further layers may be added in this way.

The seed granules containing the nutrient release profile that is to be released last are produced according to the methods of the present invention. The seed granules may have a size of from 0.1 mm to 3 mm, preferably from 0.3 mm to 2 mm, and more preferably from 0.5 mm to 1 mm. The particles that are layered on top of the seed granule may also be produced in accordance with the methods of the present invention.

Where multi-profile fertilisers comprise a coating, the coating is preferably applied after all of the one or more layers have been applied. In an alternative embodiment, a coating layer may be applied between layers, or between the core material and a layer, of the multi-profile fertiliser.

The nutrient release profiles of the layers and the core material may be controlled by changing one or more of the features of the method. For instance, by varying the nutrients in the AD liquor (for example, by altering the source of waste for the AD process); the concentration of nutrients in the AD liquor; the pH of the AD liquor; the ratio of carbonate mineral to AD liquor; and the levels of adsorption onto the carbonate mineral (for example by varying the time period over which adsorption may occur, and the temperature at which adsorption takes place). In particular, the amount of particles and binder used in the method may be adjusted to ensure that a particular ratio between the nutrients in the different layers and the core material is achieved.

According to a further aspect of the present invention, there is provided a fertiliser obtainable by any one of the methods described above.

According to a further aspect of the present invention, there is provided a method for treating waste material, the method comprising: (i) subjecting the waste material to anaerobic digestion to produce a sludge containing solid components and an AD liquor; (ii) separating the nutrient rich liquor from the solid components to give an AD liquor comprising less than 10% by weight of solid components; and (iii) adsorbing nutrients from the AD liquor onto a core material comprising a carbonate mineral.

According to a further aspect of the present invention, there is provided use of a carbonate mineral for adsorbing phosphorus from AD liquor. The carbonate mineral may also be used for adsorbing nitrogen and/or potassium from AD liquor.

According a further aspect of the present invention, there is provided use of a carbonate mineral material for the control release of phosphorus from a fertiliser.

The present invention will now be described by way of example, and with reference to the accompanying Figures in which:

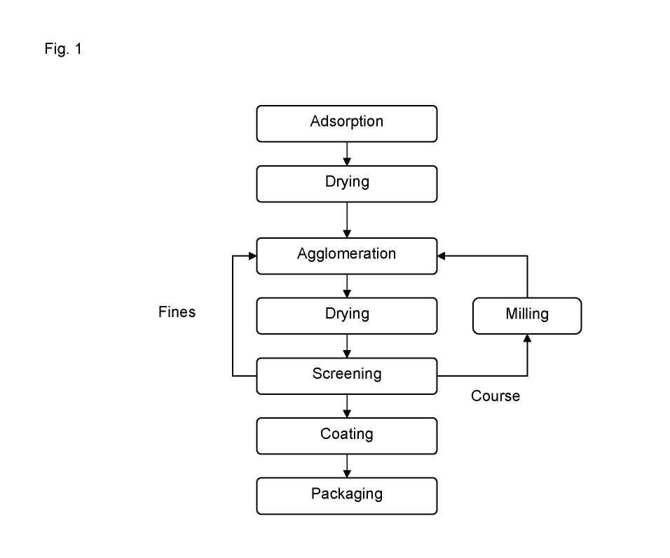

FIG. 1 is a flow chart summarizing a fertiliser production process in accordance with an exemplary embodiment of the present invention;

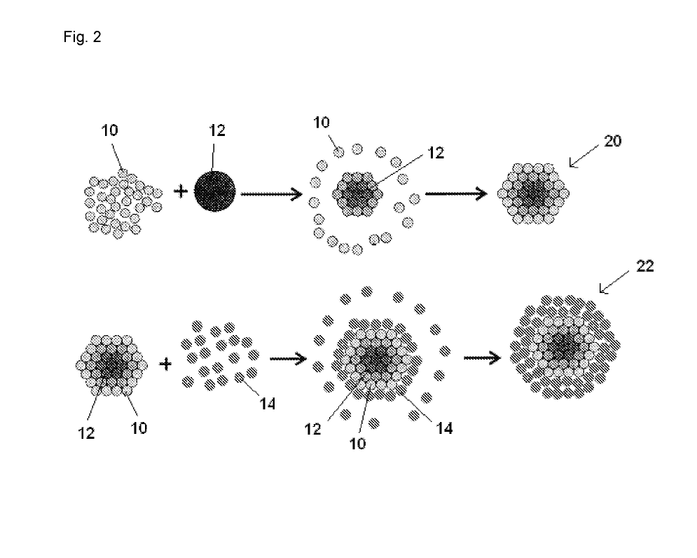

FIG. 2 shows a layering mechanism in accordance with the present invention, to produce a multi-profile fertiliser granule;

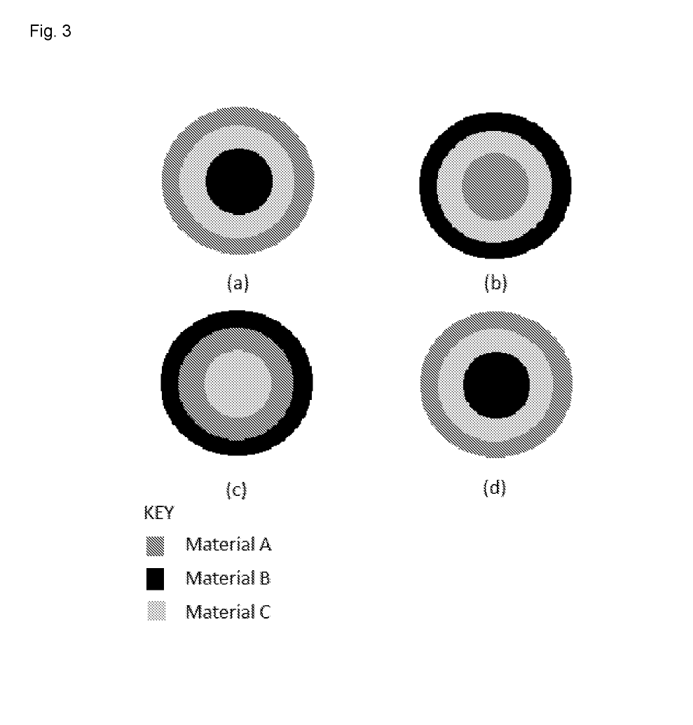

FIG. 3 shows the multi-profile fertiliser granule in accordance with an exemplary embodiment of the present invention;

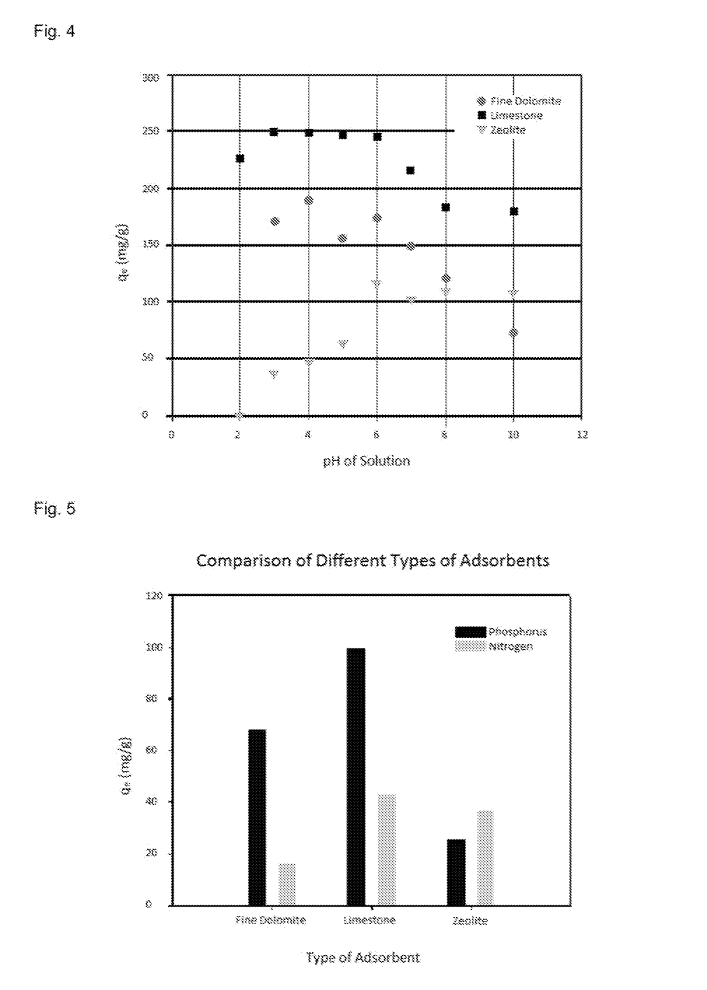

FIG. 4 demonstrates the superior adsorption of phosphorous ions from a solution onto carbonate mineral materials of the invention (dolomite and limestone) at pH values of less than 10 as compared with the adsorption onto zeolite;

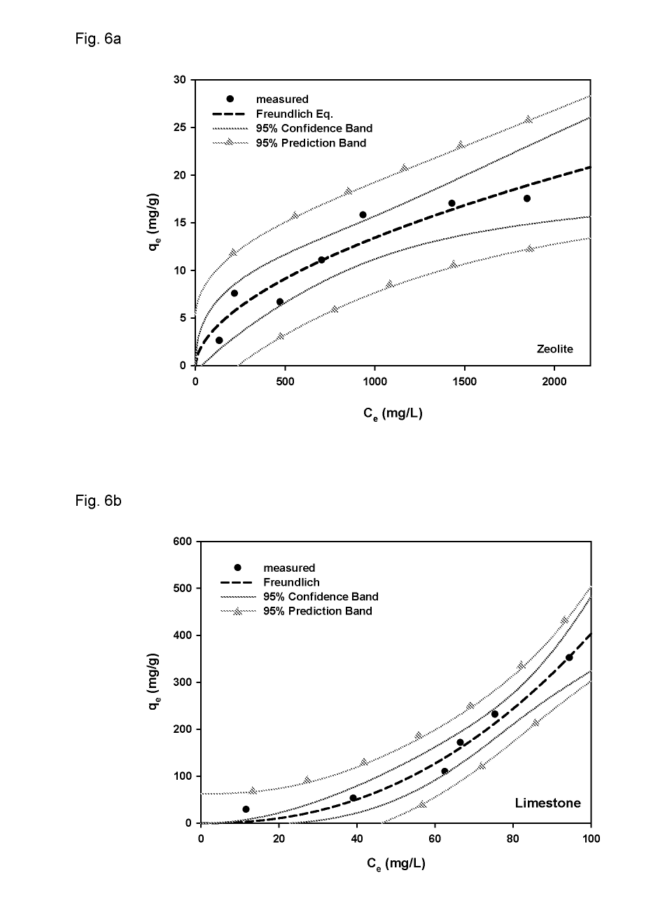

FIG. 5 demonstrates the superior adsorption of phosphorus onto 20 g of carbonate mineral materials of the invention (dolomite and limestone) in 1 L of a 2000 ppm ammonia chloride and phosphate solution as compared with the adsorption onto zeolite;

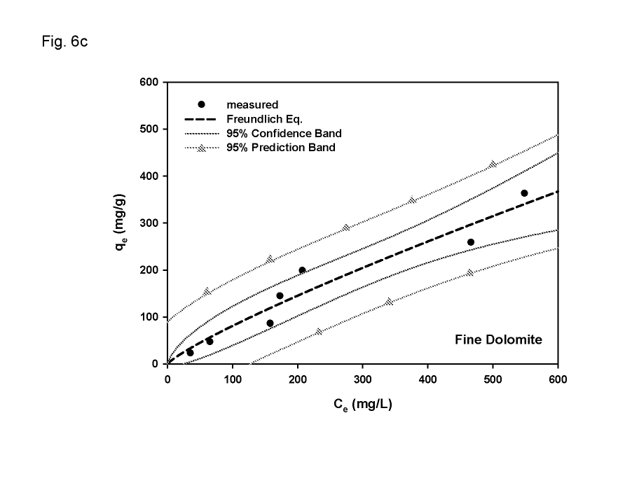

FIGS. 6a to 6c demonstrate the superior adsorption of phosphorus onto 1 g of carbonate mineral materials of the invention (dolomite and limestone) in 1 L of solution with a pH of 3.6 as compared with the adsorption onto zeolite;

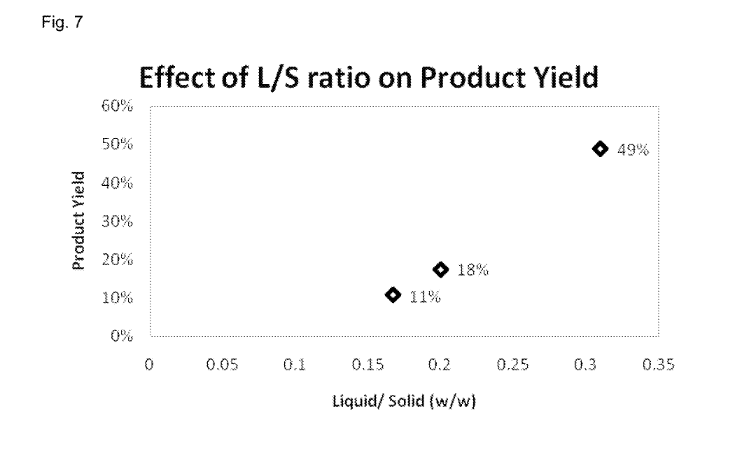

FIG. 7 shows the effect of the ratio of AD liquor to limestone particles during granulation on the product yield.

A method of producing organic fertiliser from AD liquor in accordance with the present invention is summarised in FIG. 1. A first step of the method is an adsorptive process. In this process particulate limestone or dolomite is contacted with AD liquor. Nutrients from the AD liquor are adsorbed onto the particles. Following adsorption, in the second step, the nutrient laden particles are dried to remove the excess moisture. Next, in a third step of the method, there is an agglomeration step. In this step, the dried nutrient-laden particles are formed into granules of a target size using a high shear granulation technique. As part of the agglomeration step, a polymeric binder is added as a solution to the particles. The product of the third step is a wet product and therefore, in a fourth step of the method, the wet product is dried to less than 3% moisture. Following drying, in a fifth step of the method, is a screening process. In this process, the dried granules are passed through a set of sieves to remove undersized (fines) and over-sized (coarse) granules from the product. The undersized granules are recycled to step three of the method, for use as feed to the agglomeration unit. The oversized granules are crushed before also being recycled to step three of the method as feed for the agglomeration unit. The agglomeration, drying and screening processes are repeated until sufficient granules in the desired size range have been obtained. In a sixth step of the process, the granules are coated. A seventh step of the process includes a packaging step. In this step, the coated granules are packaged into containers of suitable size and dimensions for the finished fertiliser.

A method of forming multi-profile granules in accordance with the present invention is shown in FIG. 2. In this method, particles having a second nutrient release profile (10) are layered onto a seed granule having a first nutrient release profile (12). This gives a multi-profile granule (20) with two different nutrient release profiles. If desired, as shown in FIG. 2, the multi-profile granule (20) may be exposed to further layering with particles having a third nutrient release profile (14). This gives a multi-profile granule (22) with three different release profiles.

A diagram of multi-profile granules in accordance with the present invention is shown in FIG. 3. Each granule consists of a different permutation of materials A, B and C. Using granule (a) as an example, material A is required by the plant at an early stage of growth, so it is placed on the outside of the granule. Similarly, material C is required by the plant at a later stage of growth, so it is placed in the middle layer of the granule. Material B is required at an even later stage of growth, so it is placed in the core of the granule. The depiction of the multi-profile granules in the FIGS. 2 and 3 is, of course, simplified. For instance, granules produced in accordance with the method of the invention may be polydispersed, i.e. a variety of shapes and sizes.

### EXAMPLE 1

The pH of a phosphate solution was varied, in order to assess the effect of pH on the adsorption of phosphate ions carbonate mineral materials of the invention (dolomite and limestone) and zeolite adsorbents. The results are shown in FIG. 4.

The materials of the invention demonstrate much higher adsorption of phosphate ions at pH values below 10 than the zeolite. In particular, the limestone showed the highest adsorption at all pH levels. The highest levels of adsorption for both fine dolomite and limestone occur when the solution has a pH in the range of from 2 to 8. In contrast, the adsorption of phosphate onto zeolite shows a marked decrease at lower pH values.

### EXAMPLE 2

The adsorption of phosphorous and nitrogen from highly concentrated solutions (2000 ppm ammonium chloride and phosphate solution) onto carbonate mineral materials in accordance with the present invention (dolomite, limestone) and zeolite was measured. 20 g of adsorbent material was added per L of solution. The concentration of the solution is a close match to the concentration levels of the nutrients in an AD slurry. The results are shown in FIG. 5.

The results show that the adsorption of phosphorus onto the carbonate mineral materials in accordance with the present invention (dolomite and limestone) is much higher than the adsorption of phosphorus onto zeolite. Indeed, the dolomite is more than twice as adsorptive of phosphorus as the zeolite, and the limestone is over three times as adsorptive of phosphorus as the zeolite. Limestone also shows the best adsorption of ammonium ions.

### EXAMPLE 3

The effect of the initial concentration of phosphorus in solution on the adsorption capacity of zeolite and carbonate mineral materials in accordance with the present invention (limestone and dolomite) is shown in FIGS. 6a, 6b and 6c, respectively. The pH of the solution in the examples is 3.6. 1 g of adsorbent material was added per L of solution.

Much higher adsorption was obtained over the same range of initial concentrations for the limestone and dolomite powder than for the zeolite. The zeolite shows by far the least adsorption, with adsorption of between 15 mg/g and 20 mg/g of phosphorus at a concentration of just below 2000 mg/L. The same adsorption (i.e. of between 15 mg/g and 20 mg/g) is achieved by the limestone when the concentration is less than 20 mg/L, and by dolomite when the concentration is less than 100 mg/L.

### EXAMPLE 4

The effect of the ratio of AD liquor to limestone powder during granulation on the product yield (the percentage of granules in the required size range) was assessed. The results are shown in FIG. 7.

The product yield increases with an increasing ratio of AD liquor to limestone powder, thereby demonstrating that AD liquor can be used as the binder. Using the method, good yields of granules have been obtained with a target size range was from 1 to 2 mm and with a target size range was from 2.36 to 2.8 mm.

In conclusion, the data shows that carbonate mineral materials in accordance with the present invention (limestone and dolomite) exhibit higher significantly higher adsorption of phosphorus from a solution than other mineral materials, such as zeolite. The effect is particularly pronounced when the solution has a pH of from 2 to 8.

1-45. (canceled)

46. A fertilizer comprising:
phosphorus adsorbed onto a core material comprising a carbonate mineral, wherein the phosphorus is present in an amount of at least 50 mg per 1 g of core material.

47. The fertilizer of claim 46, wherein the fertilizer further comprises nitrogen adsorbed onto the core material, in an amount of at least 15 mg per 1 g of core material.

48. The fertilizer of claim 46, wherein the fertilizer further comprises potassium adsorbed onto the core material, in an amount of at least at least 10 mg per 1 g of core material.

49. The fertilizer of claim 46, wherein the carbonate mineral is limestone or a dolomitic material.

50. The fertilizer of claim 46, wherein the core material comprises a mixture of carbonate minerals.

51. The fertilizer of claim 46, wherein the fertilizer is in the form of granules.

52. The fertilizer of claim 51, wherein the granules have a size of from 0.1 to 10 mm.

53. The fertilizer of claim 46, wherein the fertilizer further comprises a polymeric binder.

54. The fertilizer of claim 53, wherein the polymeric binder is an organic binder.

55. The fertilizer of claim 53, wherein the polymeric binder is AD liquor.

56. The fertilizer of claim 46, wherein the fertilizer further comprises one or more layers on the surface of the core material, such that the fertilizer comprises at least two different nutrient release profiles.

57. The fertilizer of claim 46, wherein the fertilizer further comprises a coating.

58. The fertilizer of claim 58, wherein the coating is an organic wax or a hydrophobic polymeric compound.

59. A method of producing a solid fertilizer, the method comprising:
adsorbing nutrients from an AD liquor onto a core material comprising a carbonate mineral, wherein the AD liquor comprises less than 20% by weight of solid components.

60. The method of claim 59, wherein the AD liquor has a pH of from 2 to 8.

61. A method of producing a solid fertilizer, the method comprising:
adsorbing nutrients from an AD liquor onto a core material comprising a carbonate mineral, wherein the AD liquor has a pH of from 2 to 8.

62. The method of claim 61, wherein the AD liquor comprises less than 20% by weight of solid components.

63. The method of claim 59, wherein the carbonate mineral is limestone or a dolomitic material.

64. The method of claim 59, wherein the core material comprises a mixture of carbonate minerals.

65. The method of claim 59, wherein the nutrients include a phosphorus source.

66. The method of claim 65, wherein the phosphorus source is present in an amount of from 250 to 2000 mg per 1 L of AD liquor.

67. The method of claim 59, wherein the nutrients include a nitrogen source.

68. The method of claim 67, wherein the nitrogen source is present in an amount of from 250 to 2000 mg per 1 L of AD liquor.

69. The method of claim 59, wherein the nutrients include a potassium source.

70. The method of claim 59, wherein the AD liquor is from the anaerobic digestion of organic waste.

71. The method of claim 59, wherein the nutrients from 1 L of liquor are adsorbed onto from 1 mg to 20 g of core material.

72. The method of claim 59, wherein the carbonate material is exposed to the liquor for a period of at least 24 hours.

73. The method of claim 59, wherein the carbonate material is exposed to the liquor at a temperature of at least room temperature.

74. The method of claim 59, wherein the carbonate mineral is in the form of particles.

75. The method of claim 74, wherein the method further comprises forming the particles into granules by agglomeration.

76. The method of claim 75, wherein the granules have a size of from 0.1 to 10 mm.

77. The method of claim 75, wherein agglomeration is carried out using high shear granulation, drum granulation, fluidized bed granulation, twin extrusion or pan granulation.

78. The method of claim 75, wherein a polymeric binder is added during agglomeration.

79. The method of claim 78, wherein the polymeric binder is an organic binder.

80. The method of claim 78, wherein the polymeric binder is the AD liquor.

81. The method claim 59, wherein the method further comprises forming one or more layers on the surface of the core material, such that the fertilizer comprises at least two different nutrient release profiles.

82. The method of claim 81, wherein the layers are formed on the surface of the core material by high shear granulation.

83. The method of claim 81, wherein the core material is in the form of a seed granule with a size of from 0.1 to 2 mm.

84. The method of claim 59, wherein the method further comprises providing a coating.

85. The method of claim 84, wherein the coating is an organic wax or a hydrophobic polymeric compound.

86. A method for treating waste material, the method comprising:
subjecting the waste material to anaerobic digestion to produce a sludge containing solid components and a nutrient rich liquor;
separating the nutrient rich liquor from the solid components to give an AD liquor comprising less than 20% by weight of solid components; and
adsorbing nutrients from the AD liquor onto a core material comprising a carbonate mineral.
